(19) United States
(12) Patent Application Publication
(10) Pub. No.: US 2014/0184633 A1
(43) Pub. Date: Jul. 3, 2014

(54) CONSERVATIVE BOUNDING REGION RASTERIZATION

(71) Applicant: NVIDIA Corporation, (US)

(72) Inventors: Jeffrey A. Bolz, Austin, TX (US); Mark Kilgard, Austin, TX (US)

(73) Assignee: NVIDIA CORPORATION, Santa Clara, CA (US)

(21) Appl. No.: 13/731,978

(22) Filed: Dec. 31, 2012

(51) Int. Cl. G06T 11/40

(52) U.S. Cl. CPC G06T 11/40
USPC 345/589

(57) ABSTRACT

A method for rendering paths. The method includes accessing data comprising a path, stenciling the path, wherein a bounding region of a plurality of stencil samples updated during the stenciling is accumulated, and provoking GPU hardware to produce a rasterized region for covering the bounding region as one object without interior edges.

### FIELD OF THE INVENTION

The present invention is generally related to computer graphics systems.

### BACKGROUND OF THE INVENTION

Recent advances in computer performance have enabled graphic systems to provide more realistic graphical images using personal computers, home video game computers, handheld devices, and the like. In such graphic systems, a number of procedures are executed to “render” or draw graphic primitives to the screen of the system. A “graphic primitive” is a basic component of a graphic picture, such as a vertex, polygon, or the like. Rendered images are formed with combinations of these graphic primitives. Many procedures may be utilized to perform graphics rendering.

Specialized graphics processing units (e.g., GPUs, etc.) have been developed to optimize the computations required in executing the graphics rendering procedures. The GPUs are configured for high-speed operation and typically incorporate one or more rendering pipelines. Each pipeline includes a number of hardware-based functional units that are optimized for high-speed execution of graphics instructions/data, where the instructions/data are fed into the front end of the pipeline and the computed results emerge at the back end of the pipeline. The hardware-based functional units, cache memories, firmware, and the like, of the GPU are optimized to operate on the low-level graphics primitives (e.g., comprising “points”, “lines”, “triangles”, etc.) and produce real-time rendered images.

“Path rendering” is a well-established resolution-independent approach to 2D computer graphics characterized by the specification of graphics objects as paths. A path is a sequence of trajectories and contours. In this context, a trajectory is a connected sequence of path commands. Path commands include line segments, Bézier curve segments, and partial elliptical arcs. Each path command has an associated set of numeric parameters known as path coordinates. When a pair of path coordinates defines a 2D (x,y) location, this pair is a control point. Intuitively a trajectory corresponds to pressing a pen's tip down on paper, dragging it to draw on the paper, and eventually lifting the pen.

A contour is a trajectory with the same start and end point; in other words, a closed trajectory. These contours and trajectories may be convex, self-intersecting, nested in other contours, or may intersect other trajectories/contours in the path. There is generally no bound on the number of path segments or trajectories/contours in a path. For a so-called rendering “primitive”, paths can be quite complex.

Paths are rendered by either filling or stroking the path. Conceptually, path filling corresponds to determining what points (framebuffer sample locations) are logically “inside” the path. Stroking is roughly the region swept out by a fixed-width pen that is centered on the trajectory that travels along the trajectory orthogonal to the trajectory's tangent direction.

Salient features of path rendering systems include the ability to both fill and stroke paths (see FIGS. 1A-1C), to apply constant coloring as well as color gradients, restricting the rendering of one path to the region within another arbitrary so-called clipping path, arranging the rendering of paths into a hierarchy of objects with nested transformations, arranging paths into layers and blending among those layers, and embellishing the process of stroking paths with support for end caps, join styles, and dashing.

GPUs can greatly accelerate the rendering of paths with a “stencil, then cover” method for path rendering. This method renders a path in two steps: first, stenciling the path's filled or stroked coverage into a stencil buffer; second, covering the path's filled or stroked coverage with a conservatively rasterized region. Normally each color sample has a single corresponding stencil sample. In order to minimize aliasing artifacts in the path rendering process, it is highly desirable to determine rasterized path coverage at multiple sub-pixel locations within a pixel. In order to achieve any acceptable level of quality for path rendering, path rasterization typically should test 8 or more sub-pixel locations per pixel.

“Stencil, then cover” methods can improve quality within a reasonable memory budget by maintaining a sufficient plurality of stencil samples per pixel and performing the rasterization for the stenciling step at all these sub-pixel locations. Existing anti-aliasing methods use supersampling or multi-sampling to maintain a one-to-one mapping of a color samples to a corresponding stencil sample and rasterization sample location. Such approaches are expensive because color samples are often 32-bit (or larger) values while stencil samples are often 8-bit (or smaller) values so adding additional stencil samples requires a substantially greater amount of storage and processing associated with color. There is a substantial processing, data storage, and power consumption cost associated with maintaining a corresponding color sample for every coverage location tested during the stenciling of paths. For this reason, it is advantageous to associate a single color sample with multiple stencil samples and their corresponding rasterization locations. Color samples can then be updated during the cover step based on the aggregate result of their associated plurality of stencil sample coverage determinations.

For example, if the GPU associates 4 stencil samples (and corresponding rasterization locations) with 1 color sample and maintains 4 color samples per pixel, the effective number of stencil samples per pixel is 16. In this configuration, the stencil step for “stencil, then cover” operates at 16 stencil samples per pixel while shading and blending during the “cover” step operates at 4 color samples per pixel. During the cover step, a fractional stencil test result is computed based on the 4 Boolean stencil test results for each stencil sample corresponding to the color sample. For example, if three of the four samples passed the stencil test during the cover step, the fractional stencil test result for the color sample would be 75% and the shaded color for the color sample should be modulated by 75% prior to blending and update of the color sample.

A problem with this approach arises when the cover geometry is broken up into triangles for efficient hardware rasterization. The cover geometry is typically represented as a rectangle or polygonal convex hull conservatively bounding the path's region. GPU rasterizers typically rasterize arbitrary rectangle or convex polygons as two or more triangles to simplify and regularize the rasterization process. While logically the covering geometry is a single rectangle or polygonal convex hull, breaking the covering geometry into triangles creates internal seams or edges. This creates a situation where stencil samples and their associated rasterization locations associated with a single color sample may belong to different triangle primitives, forcing the associated color sample to “straddle” two (or more) triangle primitives. In this case, the color sample may be blended by the partial coverage of each primitive. This will lead to visible blending artifacts at these interior seams of the covering geometry. For example, if triangle M covers 2 stencil samples associated with color sample A while triangle N covers the other 2 stencil samples associated with color sample A and all the samples pass the stencil, the color sample would be blended twice, each time modulated by 50% when the correct behavior would be to modulate by 100% and blended once. Two blends modulated by 50% would have a different result. In general, any color samples straddling stencil samples belonging to different triangles of the covering geometry will be prone to incorrect blending.

The present invention addresses implementation and quality ramifications that result from extending the “stencil, then cover” approach to rasterization scenarios where a single color sample is associated with a plurality of stencil values and coverage locations.

A related problem is efficiently generating covering geometry for the cover step that guarantees it conservatively covers all the samples generated during the stencil step of “stencil, then cover” path rendering. Existing methods require the computation, storage, and rendering of polygonal bounding regions.

A method to avoid color samples straddling interior seams of covering geometry and that guarantees conservative covering geometry without explicit polygonal bounding regions is therefore desirable.

### SUMMARY OF THE INVENTION

In one embodiment, the present invention is implemented as a GPU acceleration method for rendering paths. The method includes accessing data comprising a path, stenciling the path, wherein a bounding region of a plurality of stencil samples updated during the stenciling is accumulated, and provoking GPU hardware to produce a rasterized region for covering the bounding region as one object without interior seams. In the preferred embodiment, the bounding region is maintained as an image-space bounding box because of the ease of accumulating a conservative bounding box during rasterization and the ease of rendering such a rectangle without interior seams. However, it will be recognized by one of ordinary skill in the art that the present invention may be practiced with alternative bounding region representations.

The foregoing is a summary and thus contains, by necessity, simplifications, generalizations and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention is illustrated by way of example, and not by way of limitation, in the figures of the accompanying drawings and in which like reference numerals refer to similar elements.

FIG. 1A shows a prior art example of rendering an intricate 2D scene as many filled and stroked paths.

FIG. 1B shows a prior art example of rendering an intricate 2D scene as many filled and stroked paths.

FIG. 1C shows a prior art example of rendering an intricate 2D scene as many filled and stroked paths.

FIG. 2 shows the basic steps of a prior art “stencil, then cover” path rendering process.

FIG. 3 shows how bounding geometry for the cover step results in internal seams when the bounding geometry is broken into triangle primitives in accordance with one embodiment of the present invention.

FIG. 4 shows how color samples associated with multiple coverage samples can straddle internal seams in accordance with one embodiment of the present invention.

FIG. 5 shows how stencil geometry can be rendered while collecting a bounding region, specifying plane equations for the cover step, and then performing the cover step by rasterizing the previously collected bounding region in accordance with one embodiment of the present invention.

FIG. 6 shows how a sequence of primitives can be received and rasterized while accumulating their bounding region as a bounding box in accordance with one embodiment of the present invention.

FIG. 7 shows how a command to rasterize a previously accumulated region representation can be received in accordance with one embodiment of the present invention.

FIG. 8 shows a computer system in accordance with one embodiment of the present invention.

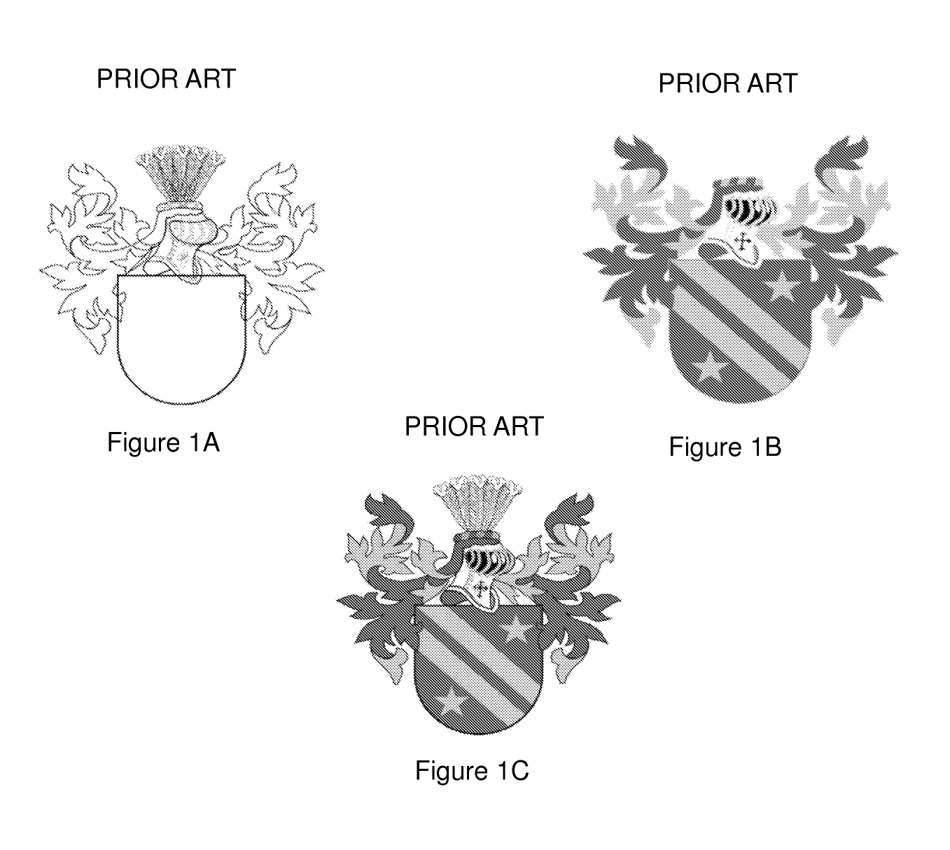

### DETAILED DESCRIPTION OF THE INVENTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail as not to unnecessarily obscure aspects of the embodiments of the present invention.

### NOTATION AND NOMENCLATURE

Some portions of the detailed descriptions, which follow, are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of non-transitory electrical or magnetic signals capable of being stored, transferred, combined, compared, and otherwise manipulated in a computer readable storage medium of a computer system. It has proven convenient at times, principally for reasons of common usage, to refer to these signals as bits, values, elements, symbols, characters, terms, numbers, or the like.

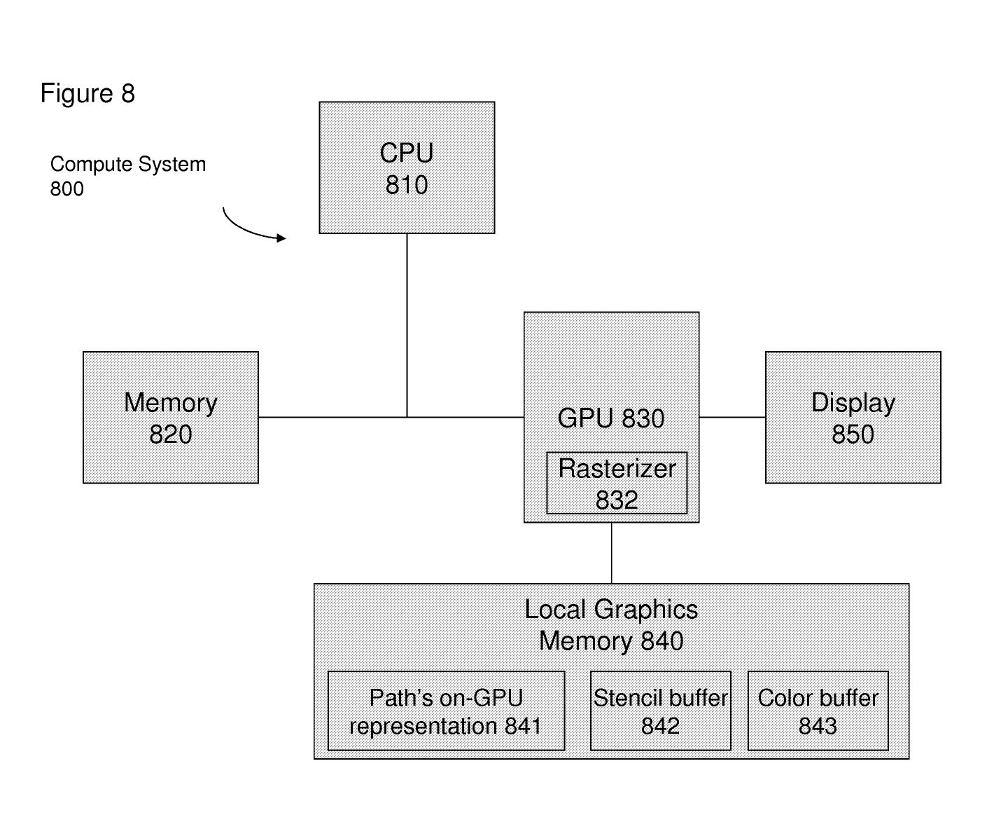

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of a computer system (e.g., computer system 800 of FIG. 8), or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention implement a new rasterization mode primarily useful for path rendering. In conventional rasterization, primitives (such as triangles) are rasterized one at a time, and the rasterization process first determines which “coarse” tiles may be updated by the triangle and then for each coarse tile determines exactly which samples are covered by the triangle. For conventional 3D rendering that's almost always the desired result, however GPU-acceleration of path rendering is implemented as a two-step process where the first step generates “coverage” information in one buffer and the second step shades all covered samples. The second step typically resets the coverage information determined in the first step so the “stencil, then cover” process can be repeated for additional paths to render.

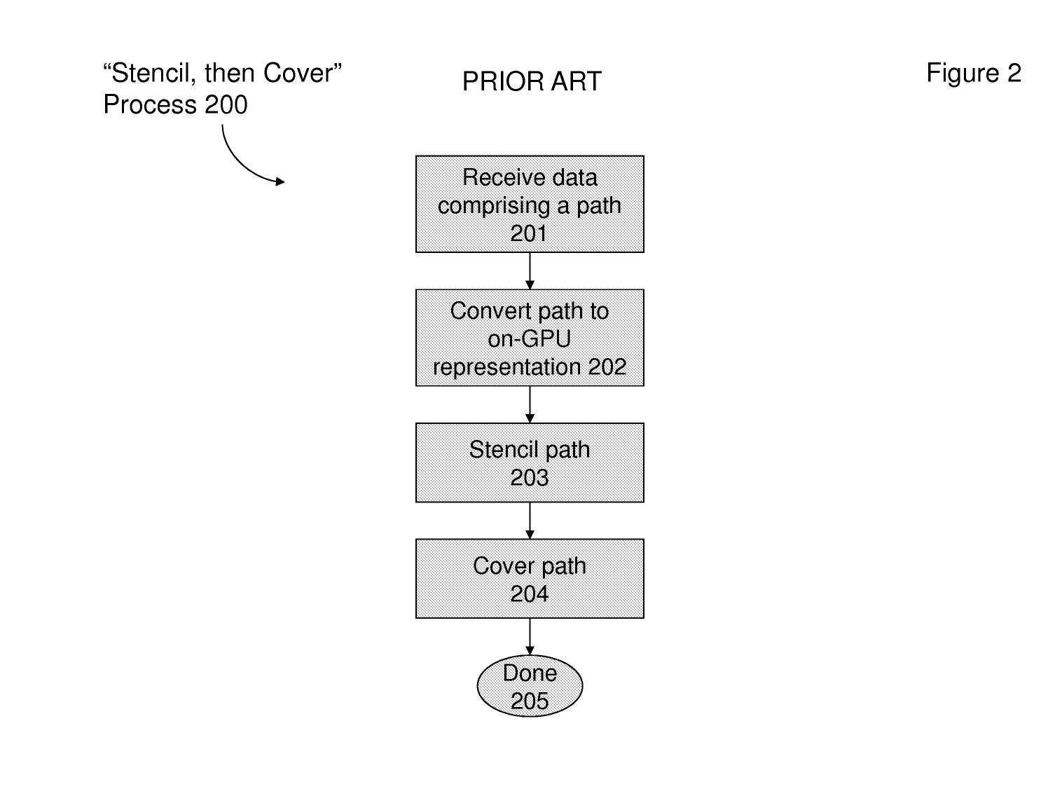

FIG. 2 reviews the prior art for rendering paths with the “stencil, then cover” process 200. Data comprising a path to render is received 201. The path data is converted to an on-GPU representation 202; if the path has previously been rendered, this step will not be necessary if the on-GPU representation is still valid and available. The on-GPU representation of the path consists of both geometry and associated data for stenciling and covering the path. Rendering of the path proceeds with a step to stencil the path 203. In this step, the on-GPU representation's stencil geometry and associated data is appropriately rasterized to the stencil buffer such that the net result is the stroked or filled region of the path is determined by the subsequent state of the stencil buffer. The second step covers the path 204. In this step, the on-GPU representation's cover geometry and associated data is rasterized while testing and resetting the stencil buffer and shading the color buffer. When this “stencil, then cover” process 200 is done 205, the stencil buffer is typically in a state, due to the reset of the stencil buffer when covering the path 204, such that the process can be repeated for a subsequent path.

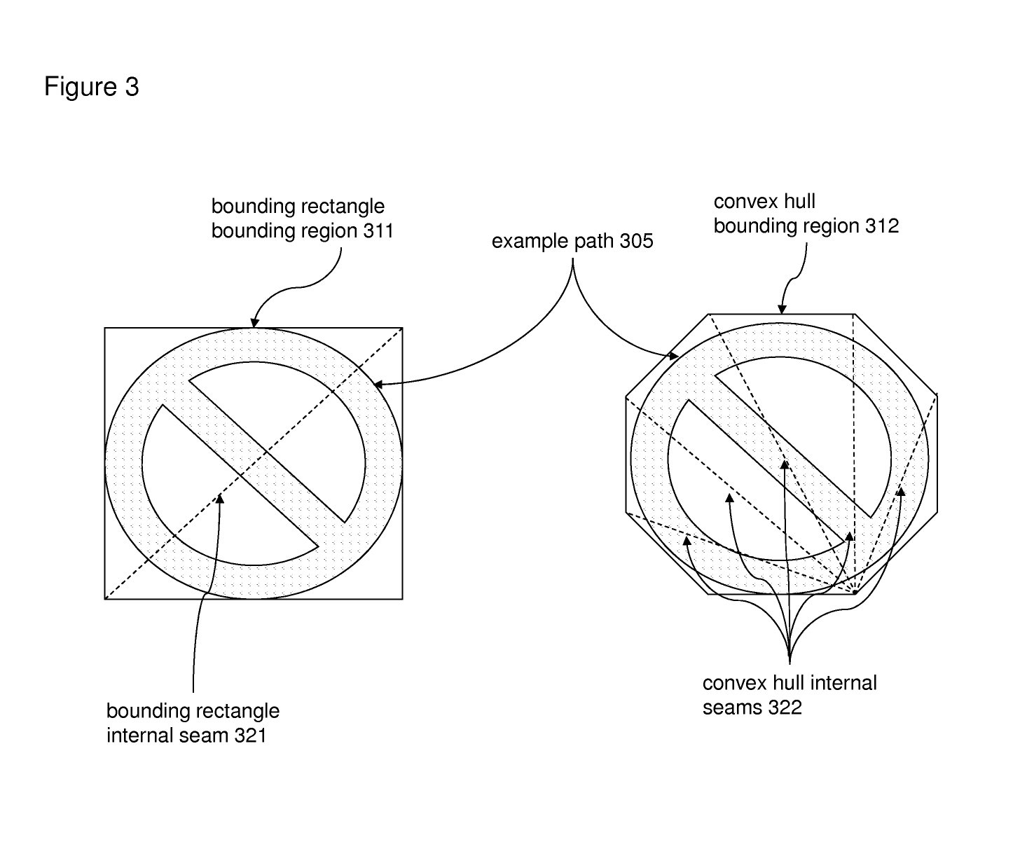

FIG. 3 shows two examples of bounding regions for rendering example path 305 during path covering 204. The bounding rectangle bounding region 311 is a rectangle (not necessarily image-space aligned). In order to rasterize the bounding rectangle 311 as triangles, the bounding rectangle must be split as shown by the bounding rectangle internal seam 321. The convex hull bounding region 312 provides tighter covering geometry but results in many more convex hull internal seams 322. In either representation, internal seams are present.

When each color sample has a single associated stencil sample and coverage location, the “stencil, then cover” process 200 operates correctly in the presence of internal seams 321 or 322. However the present invention addresses the case when a color sample is associated with a plurality of stencil values and coverage locations.

When path rendering is implemented with a “Multi-Stencil” optimization, there are more coverage samples in the stencil buffer than in the color buffer. During the Cover step, the coverage information is converted into opacity stored in the alpha channel and the color is modulated by this opacity. If the cover geometry is rasterized as a sequence of triangles, then some pixels on the edge of the triangle may be partially covered by multiple triangles, and the result of this blending will produce artifacts. So embodiments of this invention are required to produce correct cover results with multi-stencil, particularly when the path is subject to arbitrary transformations on the GPU.

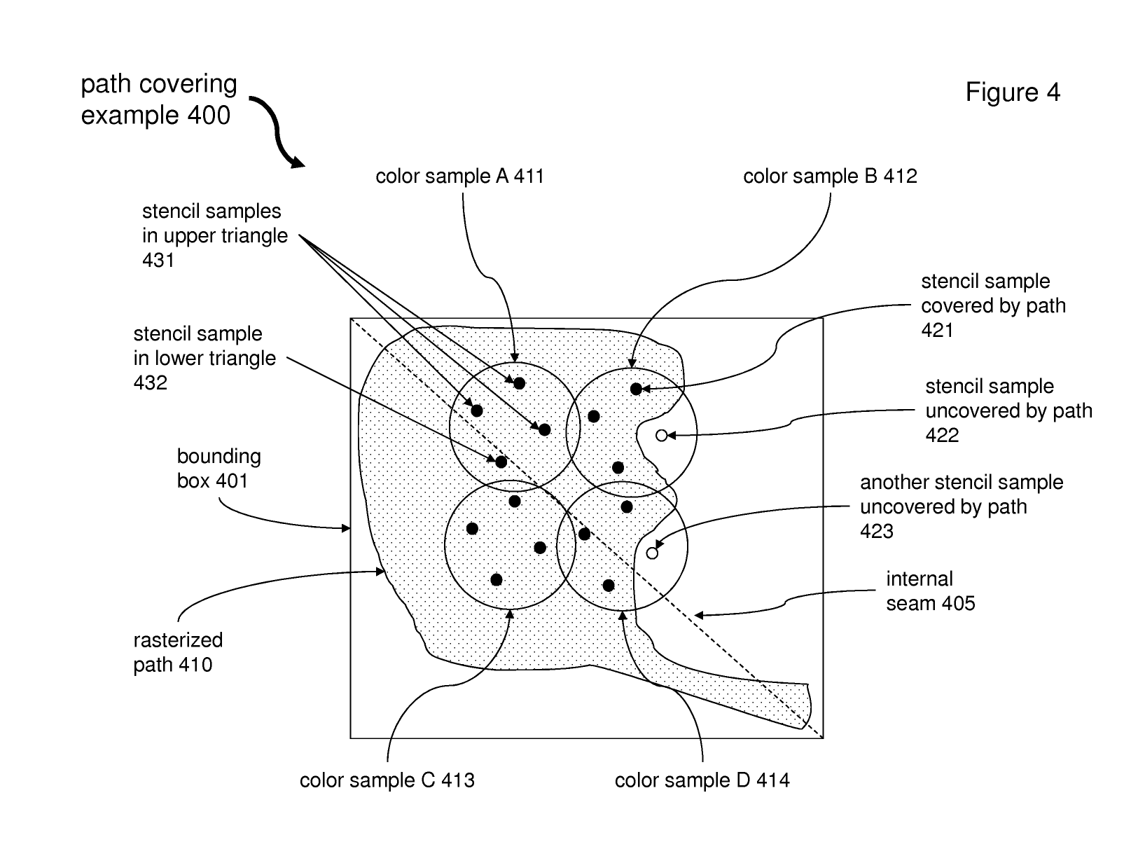

FIG. 4 shows a path covering example 400 where each color sample has a plurality of associated stencil values and coverage locations where an internal seam 405 results in incorrect path rendering results along the internal seam 405 as will be explained. To illustrate the problem created by internal seam 405, example 400 shows representative four color samples A, B, C, and D (411, 412, 413, 414) involved in the covering of rasterized path 410. Bounding box 401 is the bounding geometry for rasterized path 410. Color samples are shown as circles that enclose their respective stencil sample locations.

Each color sample illustrates a different situation. Color samples A (411) and D (414) straddle the internal seam 405 while color samples B (412) and C (413) do not straddle.

Color sample C (413) has all of its stencil samples covered by the path (shown as solid dots enclosed by 413's circle) and is completely within the lower triangle of bounding box 401. This means the color sample is 100% covered will be rasterized by a single covering triangle primitive. Color sample B (412) is similar in that all its coverage samples are completely within the upper triangle of bounding box 401, but only 75% of its stencil samples are covered by rasterized path 410. For both color samples 413 and 412 all the stencil samples for the color samples are rasterized by a single covering triangle primitive (the upper triangle for color sample 412 and lower triangle for color sample 413).

Path rasterization artifacts however arise in the case of color samples A and D (411 and 414) because these color samples have associated stencil values and coverage locations that straddle the internal seam 405. The source of these path rasterization artifacts is that the coverage of the straddling color samples is “split” between two different triangles making up bounding box 401.

Concentrating on color sample A 411, its stencil samples 431 are rasterized by the upper triangle while the stencil sample 432 is rasterized by the lower triangle. Color sample 411 is completely within the path 410 and so 100% covered but it will be 75% covered by the upper triangle and 25% covered by the lower triangle. The color of the color sample will therefore be updated twice, once with 25% coverage by the lower triangle and once with 75% coverage by the lower triangle.

The implementation of these two updates is examined in further detail. Assuming the lower triangle is rasterized first, when rendered this way, the 25% coverage update takes 25% of the path color and 75% of the background color. Then when the upper triangle is rasterized, 75% of the path color is combined with 25% of the prior sample color. Because the prior sample color includes 75% of the background color, some of the background color will “leak” into the coloring of rasterized path 410 along internal seam 405. However this should not be the case when, despite internal seam 405, the coverage of color sample 411 is 100%, meaning no background color should be present. This artifact will happen whenever an internal seam splits the stencil sample coverage for a color sample. This is undesirable and the present invention, as will be detailed, avoids this type of path rendering artifact, thereby avoiding compromised path rendering quality. Moreover path rendering standards generally disallow blending color samples more than once when rendering a path.

Concentrating on color sample D 414, a similar but different situation is shown. In this case, two stencil samples fall on either side of the internal seam 405. While the top triangle rasterizes with just 25% of the samples covered because one stencil sample 423 is uncovered by the path, the bottom triangle rasterized with 50% of the stencil samples covered. While the specific situation is different from color sample A 411, the underlying situation of the internal seam 405 “splitting” the coverage remains. Again, this leads to compromised path rendering quality.

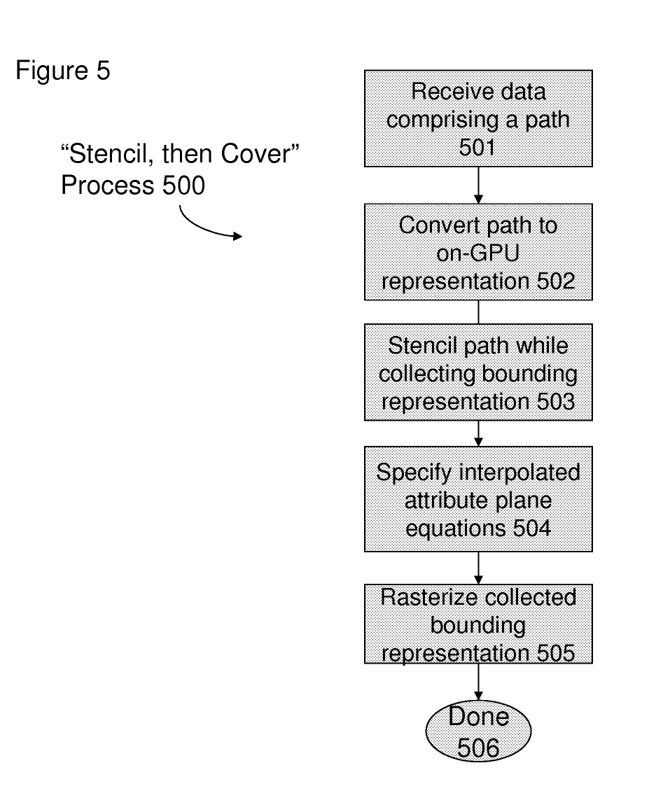

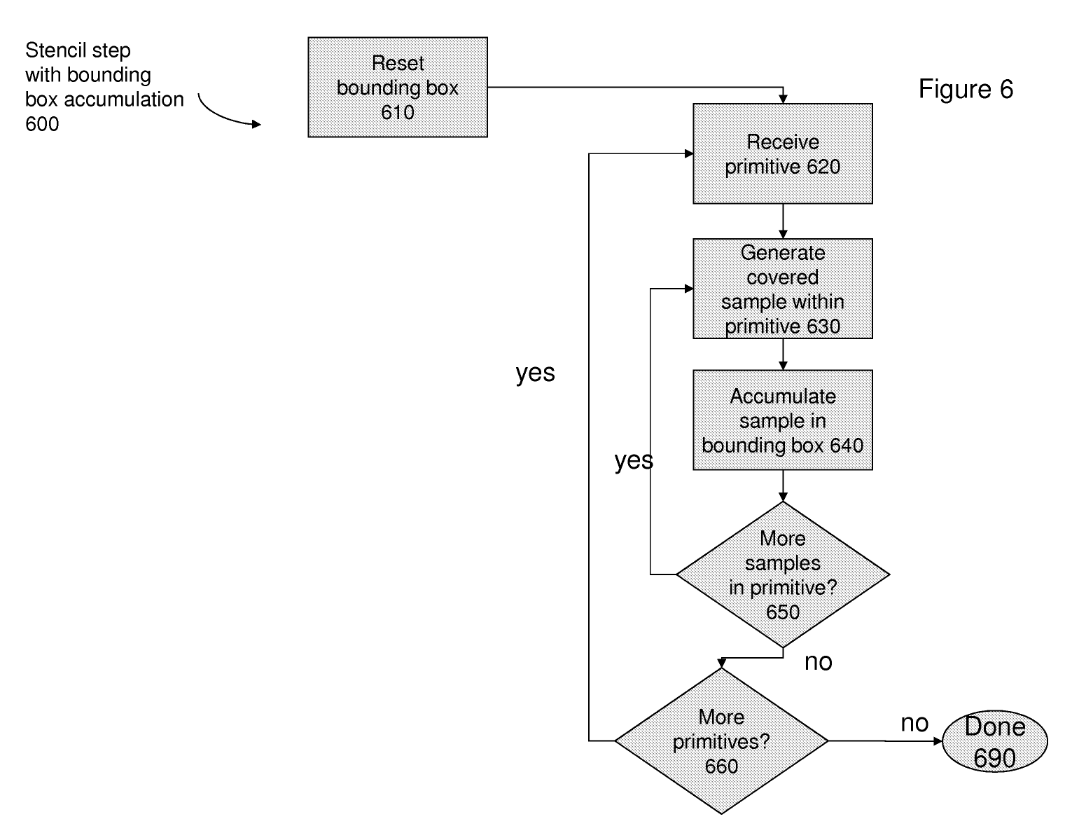

FIG. 5 shows the present invention's “stencil, then cover” process 500 to remedy the path rendering quality artifacts exemplified by FIG. 4. Operations 501 and 502 are essentially identical to the prior art's steps 201 and 202. Operation 503 is similar to operation 203 but includes collecting a bounding region from the set of updated stencil samples while stenciling the path. The specifics of the operation of 503 is deferred until the discussion of FIG. 6. The subsequent operation to specify interpolated attribute plane equations 504 allows gradients due to varying attributes such as colors or texture coordinates to be computed. Gradients are a salient feature of all path rendering systems. Not all paths require interpolated attributes so when not required, operation 504 can be skipped. A skilled practitioner of the art will recognize several methods are applicable for operation 504 to specify plane equations. In one embodiment a triangle with associated attributes is received, transformed appropriately into image space, and used to compute attribute plane equations. In another embodiment, the plane equation in path space for the path is transformed directly into image space.

The cover step in “stencil, then cover” process 500 is performed by operation 505. This operation is analogous to path covering 204 in the prior art, except rather than rasterize the bounding representation as a set of triangle primitives, which leads to internal seams 321, 322, and 405, the bounding region is rasterized directly. Skilled practitioners of the art will recognize that an image-space aligned bounding box is readily rasterized as a screen-space aligned rectangle without internal seams rather than as two (or more) triangles.

In this manner embodiments of the present invention provide a means to GPU-accelerate existing path rendering standards. Implementations of existing standards can re-target their path rendering to benefit from the substantial quality and performance benefits of GPU acceleration. For example, a web browser could be implemented to render SVG through GPU acceleration to achieve immersive web experiences at higher resolutions and quality levels than possible with only CPU-based path rendering.

FIG. 6 provides details on how a bounding box is acquired to implement operation 503. A skilled practitioner of the art will recognize that this process could be implemented within a GPU rasterizer 832. First reset the bounding box 610. Then operation 620 receives a primitive. Operation 503 expects to receive a batch of geometry primitives for stencil filling or stencil stroking a path from the on-GPU representation of a path converted by operation 202. This could be the same representation used by the prior art's operation to stencil path 203. Each primitive in the batch would be rasterized into samples. Operation 630 would generate a covered sample not previously generated from the current primitive. Operation 640 accumulates the covered sample's location in the bounding box. A skilled practitioner would recognize that other bounding regions could also be accumulated. Operation 650 determines if more samples for the current primitive should be generated. If yes, operation 630 repeats. If no, operation 660 determines if more primitives from the batch are to be processed. If yes, the process returns to 620. If no, the process is done at 690. At this point, a complete bounding region for the batch of primitives in image space is acquired.

In alternate embodiments, the accumulated bounding box could be any conservative bounding region representation of the “coverage” step's coverage. For example, a GPU with multiple rasterizer, each owning different sub-regions of the frame buffer might keep a bounding box per rasterizer. As another example, the rasterizer might keep a list of unique coarse tiles visited during the “coverage” step. Such alternative conservative bounding regions may provide tighter bounds than a simple bounding box. This has the advantage of allowing the second shading step to examine, shade, and update potentially fewer pixels.

Operation 503 may be split into two operations, where stenciling the path 203 is separate from collecting the bounding region. Sometimes the “cover” step is not performed immediately after the “stencil” step, so the bounding region must be regenerated. In this case, any geometry that bounds the stencil geometry should produce a sufficient bounding region, although possibly more conservative than necessary.

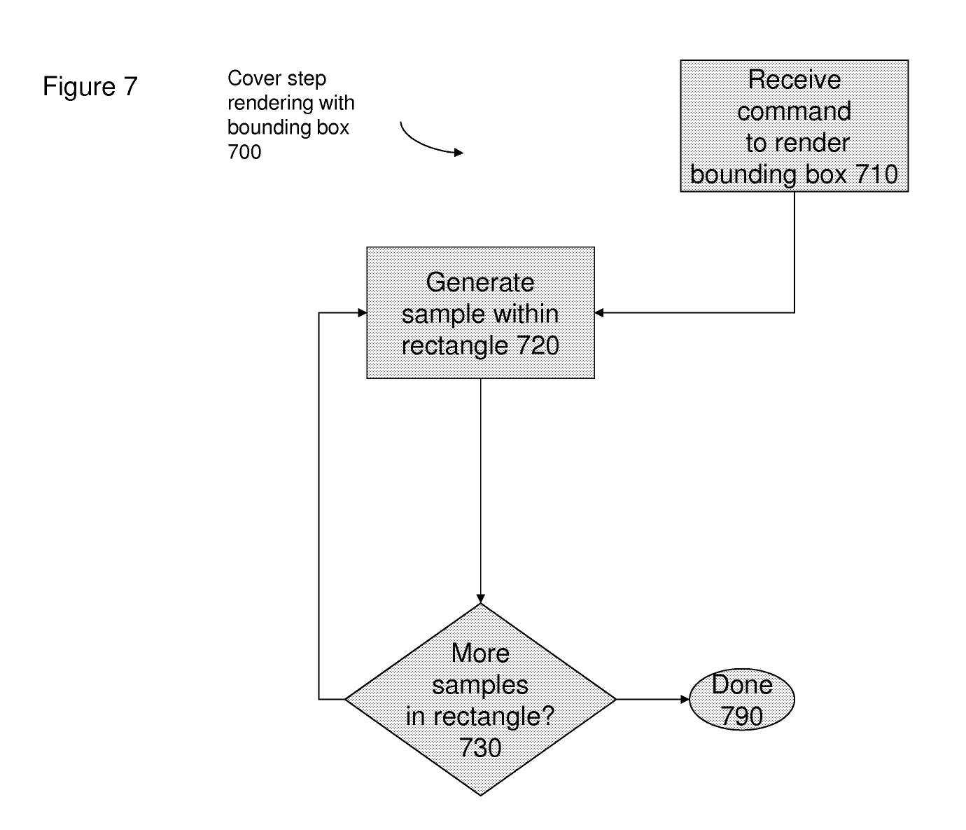

FIG. 7 provides detail on how a complete bounding box from process 600 is rendered to cover a path with a bounding box 700. Operation 710 receives a command to render an acquired bounding box. This command could be sent by operation 505. After the command is received, a rasterizer will generate a yet-to-be generated sample within the rectangle 720. Decision 730 determines if more samples need to be generated to rasterize the rectangle completely. If yes, operation 720 repeats. If no, the process is done at 790.

Skilled practitioners will recognize that the rasterization functionality in FIGS. 6 and 7 is not specific to path rendering and may be used in contexts other than path rendering.

Several advantages of the present invention are now discussed. The conservative nature of this rasterization is also beneficial when implementing “shared edge” support for path rendering. In this case, cover geometry constructed from rasterizing triangles may not be sufficient to cover samples along a shared outer edge of the path, but a bounding box bloated to a coarse raster tile will cover all samples.

Another benefit is guaranteeing each and every sample visited during the “stencil” step will be shaded during the “cover” step. This provides a level of robustness that is difficult to guarantee if object-space covering geometry is transformed instead. Under extreme projective transform, it is difficult to numerically guarantee that every sample visited during the “coverage” step is necessarily visited during the shading step because different geometry is being rendered for the cover geometry in the shading step than during the prior “coverage” step. Embodiments of the present invention however provide a robust guarantee because the shading step's geometry must reflect coverage determined in the “coverage” step.

A conservative rasterization that always fully covers coarse raster tiles is also beneficial to stencil compression because it allows the GPU's rasterization and depth-stencil processing (or ZROP) units to easily conclude that a fully covered tile is trivially re-compressible. This can increase fill rate and reduce memory bandwidth and power consumption without requiring complex logic and speculative memory reads to determine whether a partially covered tile is re-compressible.

The conservative bounding box used in this invention can either be constructed from a set of vertices provoked explicitly for this purpose, or can be reused and inherited from geometry used in the stencil step. If it can be reused from the stencil step, then in some cases the entire cover step can be executed without executing any vertex transformation work on the GPU, which may lead to significant power savings. If the cover geometry has complex shading requiring interpolated attributes, then it may be desirable to provoke geometry for the bounding box that includes attributes from which the setup unit can derive plane equations. The rasterized bounding box only requires a single set of plane equations per attribute (as opposed to per triangle), so the GPU has freedom in choosing which plane equations to select.

### Computer System Platform:

FIG. 8 shows a computer system 800 in accordance with one embodiment of the present invention. Computer system 800 depicts the components of a basic computer system in accordance with embodiments of the present invention providing the execution platform for certain hardware-based and software-based functionality. In general, computer system 800 comprises at least one CPU 810, a system memory 820, and at least one graphics processor unit (GPU) 830. A local graphics memory 840 attached to GPU 830 may maintain each path's on-GPU representation 841, stencil buffer 842, and color buffer 843 used in the rendering of paths. These memory resources could alternatively reside in memory 820. Within the GPU 830 may be one or more rasterizers 832. Within a rasterizer 832 may be implemented the process 600 to accumulate a bounding region of rasterized geometry and process 700 to render the bounding region. The CPU 810 can be coupled to the system memory 820 via a bridge component/memory controller (not shown) or can be directly coupled to the system memory 820 via a memory controller (not shown) internal to the CPU 810. The GPU 830 is coupled to a display 850. One or more additional GPUs can optionally be coupled to system 800 to further increase its computational power. The GPU(s) 830 is coupled to the CPU 810 and the system memory 820. System 800 can be implemented as, for example, a desktop computer system or server computer system, having a powerful general-purpose CPU 810 coupled to a dedicated graphics rendering GPU 830. In such an embodiment, components can be included that add peripheral buses, specialized graphics memory, IO devices, and the like. Similarly, system 800 can be implemented as a handheld device (e.g., cellphone, etc.) or a set-top video game console device such as, for example, the Xbox®, available from Microsoft Corporation of Redmond, Wash., or the PlayStation3®, available from Sony Computer Entertainment Corporation of Tokyo, Japan.

It should be appreciated that the GPU 830 can be implemented as a discrete component, a discrete graphics card designed to couple to the computer system 800 via a connector (e.g., AGP slot, PCI-Express slot, etc.), a discrete integrated circuit die (e.g., mounted directly on a motherboard), or as an integrated GPU included within the integrated circuit die of a computer system chipset component (not shown). Additionally, a local graphics memory 820 can be included for the GPU 830 for high bandwidth graphics data storage.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A method for rendering graphics primitives, comprising:
accumulating a bounding region such that the region includes samples updated by those primitives; and
rasterizing the bounding region without interior edges.

2. The method of claim 1, wherein the graphics primitives being bounded specify the coverage of a path.

3. The method of claim 2, wherein the bounding region is reset such that the stenciling and covering can be repeated on a plurality of paths.

4. The method of claim 1, wherein the rasterized region is rasterized without interior seams by GPU hardware.

5. The method of claim 1, wherein the rasterized region is rasterized as a bounding box.

6. The method of claim 1, wherein a coarse rasterization mode is implemented to increase the size of the bounding region.

7. The method of claim 1, wherein shading with attribute interpolation properties are applied to the rasterized region.

8. The method of claim 7, wherein the attribute interpolation is specified by plane equations.

9. The method of claim 8, wherein the plane equations are specified by a triangle having per vertex attributes.

10. A non-transitory computer readable media having computer readable instructions which when executed by a computer system cause the computer system to implement a computer readable media for rendering paths comprising:
accumulating a bounding region such that the region includes samples updated by those primitives; and
rasterizing the bounding region without interior edges.

11. The computer readable media of claim 10, wherein the graphics primitives being bounded specify the coverage of a path.

12. The computer readable media of claim 11, wherein the bounding region is reset such that the stenciling and covering can be repeated on a plurality of paths.

13. The computer readable media of claim 10, wherein the rasterized region is rasterized without interior seams by GPU hardware.

14. The computer readable media of claim 10, wherein the rasterized region is rasterized as a bounding box.

15. The computer readable media of claim 10, wherein a coarse rasterization mode is implemented to increase the size of the bounding region.

16. A computer system for implementing pass rendering operations, comprising:
a computer system having a processor coupled to a computer readable storage media and executing computer readable code which causes the computer system to:
accumulate a bounding region such that the region includes samples updated by those primitives; and
rasterize the bounding region without interior edges.

17. The computer system of claim 16, wherein the graphics primitives being bounded specify the coverage of a path.

18. The computer system of claim 17, wherein the bounding region is reset such that the stenciling and covering can be repeated on a plurality of paths.

19. The computer system of claim 16, wherein the rasterized region is rasterized without interior seams by GPU hardware.

20. The computer system of claim 16, wherein the rasterized region is rasterized as a bounding box.
